(19) United States
(12) Patent Application Publication
(10) Pub. No.: US 2023/0114898 A1
(43) Pub. Date: Apr. 13, 2023

(54) EFFICIENT NETWORK FLOW MANAGEMENT USING CUSTOM FILTER-BASED PACKET SAMPLING

(71) Applicant: Arista Networks, Inc., Santa Clara, CA (US)

(72) Inventors: Jeevan Kamisetty, San Jose, CA (US); Ripon Bhattacharjee, Fremont, CA (US); Purushothaman Nandakumaran, Milpitas, CA (US); Utkarsha Verma, Santa Clara, CA (US); Zhe Wang, Santa Clara, CA (US)

(21) Appl. No.: 17/496,760

(22) Filed: Oct. 7, 2021

(51) Int. Cl. H04L 47/2441; H04L 47/20; H04L 47/2483

(52) U.S. Cl. CPC H04L 47/2441; H04L 47/20; H04L 47/2483

(57) ABSTRACT

Methods, systems, and apparatuses for efficient tracking and exporting of network flows using custom filters. A network device receives network data and classifies a flow of the network data as belonging to a defined flow group from among a plurality of defined flow groups. A set of rules is identified that correspond to the defined flow group. Flow information is updated for a characteristic of the flow according to the set of rules. The network device determines, based on the flow information, that the flow satisfies a set of criteria involving the characteristic and, as a result of the determination, controls transmission of data associated with the flow.

### BACKGROUND

Traffic in an internet protocol (IP) network typically comprises a set of flows, each flow including data packets. One flow, for example, may include data packets for streaming a movie whereas another flow may include data packets for providing email to a user. Some existing network solutions provide the ability to sample packets and export flow information. However, these solutions do not facilitate granular analysis and control of network data. More particularly, existing solutions do not provide for inspection of flow level information by identifying the start or the end of a flow and send the entire packet stream with minimal flexibility. As a result, flow telemetry processing systems can be overwhelmed with excessive packet loads and unnecessary flow information.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 illustrates an environment in which a network management system operates according to one or more embodiments.

FIG. 2 illustrates an environment in which a network flow controller of the network flow management system of FIG. 1 operates according to one or more embodiments.

FIG. 3 illustrates an environment in which an example network flow controller operates to implement a plurality of flow tracker engines according to one or more embodiments.

FIG. 4 illustrates an example environment in which a network flow controller operates based on one or more sets of rules according to one or more embodiments.

FIG. 5 illustrates an example environment in which a flow tracker engine of the network flow controller operates according to one or more embodiments.

FIG. 6 example network flow system in which a network flow controller operates according to one or more embodiments.

FIG. 7 illustrates a first method of controlling flows of network traffic according to one or more embodiments.

FIG. 8 illustrates a second method of controlling flows of network traffic according to one or more embodiments.

FIG. 9 shows an example of a network device that can be incorporated in a packet processing pipeline according to one or more embodiments.

### DETAILED DESCRIPTION

Described herein are systems, methods, and devices for dynamically tracking and controlling network traffic. In the following description, for purposes of explanation, numerous examples and specific details are set forth to provide a thorough understanding of the present disclosure. It will be evident, however, to one skilled in the art that the present disclosure as expressed in the claims may include at least some of the features in these examples, alone or in combination with other features described below, and may further include modifications and equivalents of the features and concepts described herein. The term “set,” as used herein (e.g., a set of rules), refers to a non-empty collection of members.

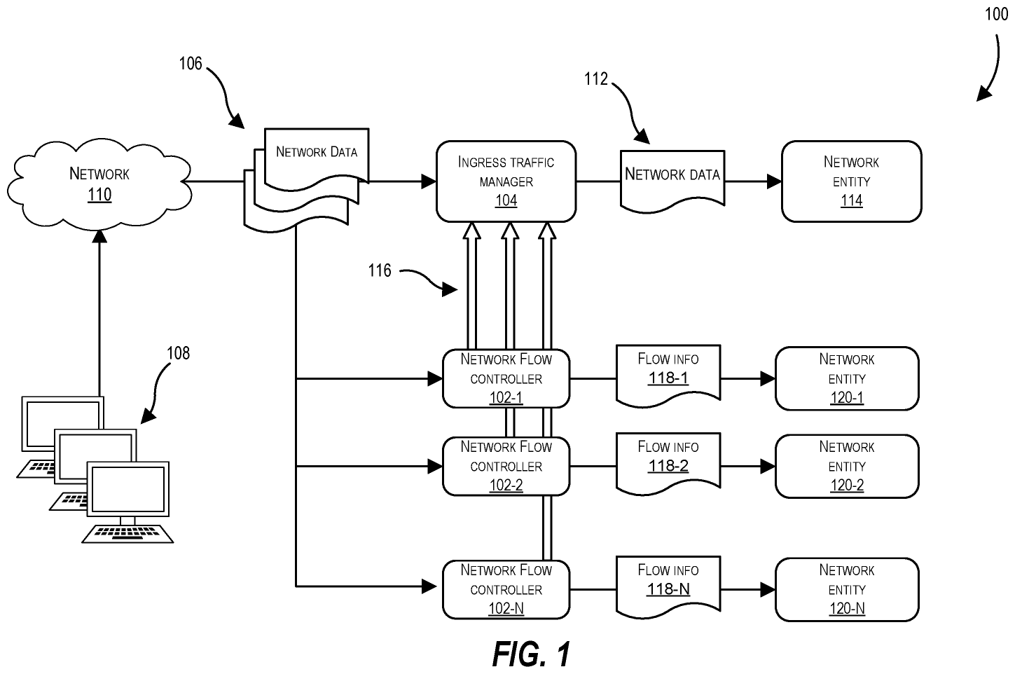

FIG. 1 illustrates an environment in which a network management system 100 operates according to one or more embodiments. The network management system 100 provides the ability to identify network traffic matching one or more defined characteristics and the ability to dynamically change filters based on traffic patterns, which improves network security and control. Some or all of the network management system 100 may be part of a network device, such as a network switch, a router, an access point, or a server, by way of non-limiting example. The network management system 100 is located in a local network and may observe network traffic internal to the local network, may observe network traffic exchanged with nodes external to the local network, or both. In some embodiments, for instance, the network management system 100 is configured to observe ingress and/or egress network traffic at an edge of a network where a local network interfaces with entities external to the local network. In some embodiments, the network management system 100 is configured to observe network traffic between internal nodes of the local network. Furthermore, the network management system 100 may be part of a packet processing pipeline for processing data packets in a communication network.

The network management system 100 includes a set of network flow controllers 102-1, 102-2, . . . , 102-N (collectively network flow controllers 102) operatively coupled to one or more ingress traffic managers 104. The network flow controllers 102 reduce the load on some network devices and improves the speed at which security and/or telemetry appliances can process and react. Network data 106 is transmitted to the network management system 100 by one or more source systems 108 over a network 110. The network data 106 is a sequence of data packets traveling from a source through a switch fabric to reach a destination and contains network data for a specific objective, such as rendering a webpage or streaming media content. The ingress traffic manager 104 and the network flow controllers 102 may be implemented as a combination of hardware and encoded logic (e.g., software, hardwired logic). For instance, the ingress traffic manager 104 may be part of a packet processing pipeline that includes a set of packet switches and linecards, and may include a collection of memory, processing units, application specific integrated circuits (ASICs), and other hardware. Each of the network flow controllers 102 may be implemented as one or more processors, network interfaces, and memory storing instructions that, as a result of execution by the one or more processors, cause the network flow controller 102 to perform as described herein.

In some embodiments, the one or more source systems 108 are computer systems that may include any type of system (e.g., software and computer hardware) configured to generate, send, receive, and/or process requests and replies either locally or over a network using software and computer hardware. Such computer systems include one or more processors, memory storing executable instructions, and one or more physical network interfaces. Non-limiting examples of computer systems include laptop computers, desktop computers, mobile devices, switches, routers, and servers (e.g., DHCP servers, database servers, application servers, file servers, print servers, mail servers). The network 110 may comprise a plurality of nodes or devices linked via network connections (either wired or wireless). The network 110 may include one or more local area networks, one or more wide-area networks, one or more public switched telephone networks, one or more private networks, and/or a number of intermediate network connections.

Each of the network flow controllers 102 monitors and analyzes the network data 106 and controls transmission of at least some of the network data 106 and/or flow information of the network data 106 based on a defined set of rules. One defined set of rules implemented by a first one of the network flow controllers 102 may be different than another defined set of rules implemented by a second one of the network flow controllers 102. One or more of the network flow controllers 102 may be communicatively coupled with the ingress traffic manager 104 and may be configured to control how the ingress traffic manager 104 directs the network data for each flow of network traffic. The term “flow,” as used herein, refers to a sequence or set of data packets having a defined set of characteristics in common. The defined set of characteristics are specified in a set of rules of a network flow controller.

The ingress traffic manager 104 may, for instance, receive the network data 106 and transmit a set of network data 112 to one or more network entities 114, which may be servers, routers, or an administrative system in a local network. The network flow controllers 102 analyze the network data 106 and may send instructions 116 to the ingress traffic manager 104 to transmit the network data 106 or a subset thereof (e.g., the network data 112) to a particular network entity with or without encapsulation. Non-limiting examples of encapsulation protocols include Virtual Extensible Local Area Network (VXLAN) protocol, generic routing encapsulation (GRE) protocol, Layer 2 Tunneling protocol, Data Link Layer or Layer 2 encapsulation (e.g., High-level data link control, Point-to-Point Protocol, Frame Relay), Layer 3 encapsulation (e.g., IPv4, IPv6), and multiprotocol label switching (MPLS) encapsulation. For instance, the ingress flow manager 104 may, based on the instructions 116, cause the network data 106 or a subset thereof to be mirrored on a particular set of ports or to a particular network entity 114.

The network flow controllers 102 receive the network data 106 and determine whether the network data 106 corresponds to a defined flow group of interest. The term “flow group,” as used herein, refers to a set of network flows that correspond to a set of attributes defined in a set of rules. If the flows 106 include network data corresponding to a defined flow group, the network flow controllers 102 track or update information associated with the defined flow group. The network flow controllers 102 may cause one or more sets of flow information 118-1, 118-2, . . . 118-N regarding the defined flow group of interest to be transmitted to one or more network entities 120-1, 120-2, . . . 120-N, which may include an entity that may not be associated with a destination IP of the network data. The network flow controllers 102 may also control aspects of the ingress traffic manager 104 (e.g., via the instructions 116) based on a determination that the network data 106 corresponds to a defined flow group of interest.

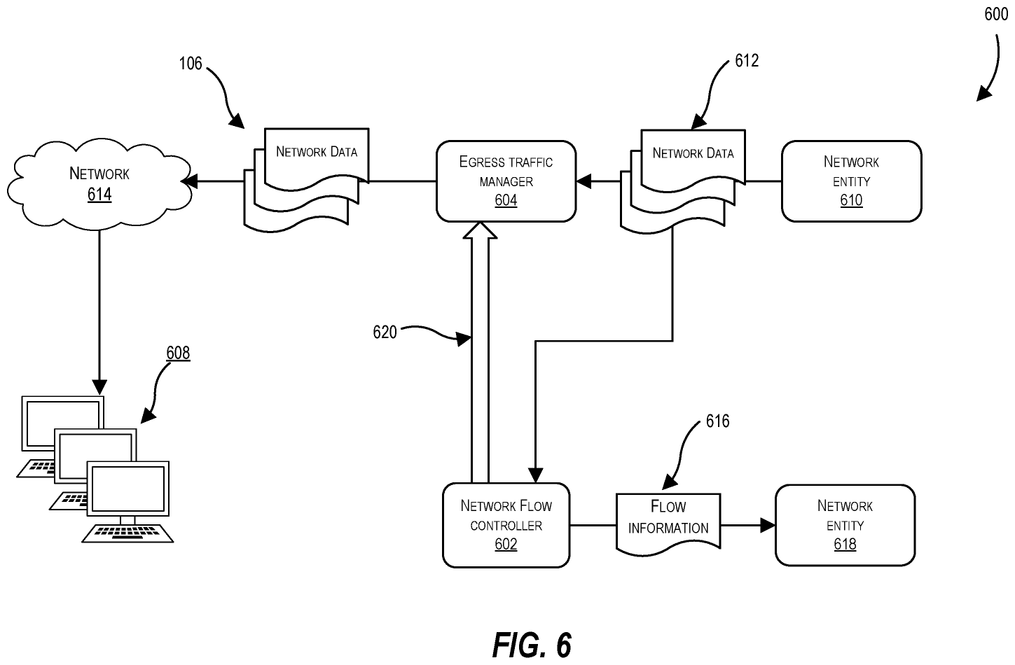

As described with respect to FIG. 6 and elsewhere herein, one or more of the network flow controllers 102 may be configured to monitor and analyze egress network traffic comprising network data to be transmitted to an entity external to a local network. In some embodiments, one or more of the network flow controllers 102 may be configured to monitor and analyze network traffic comprising network data to be transmitted between nodes internal to a local network.

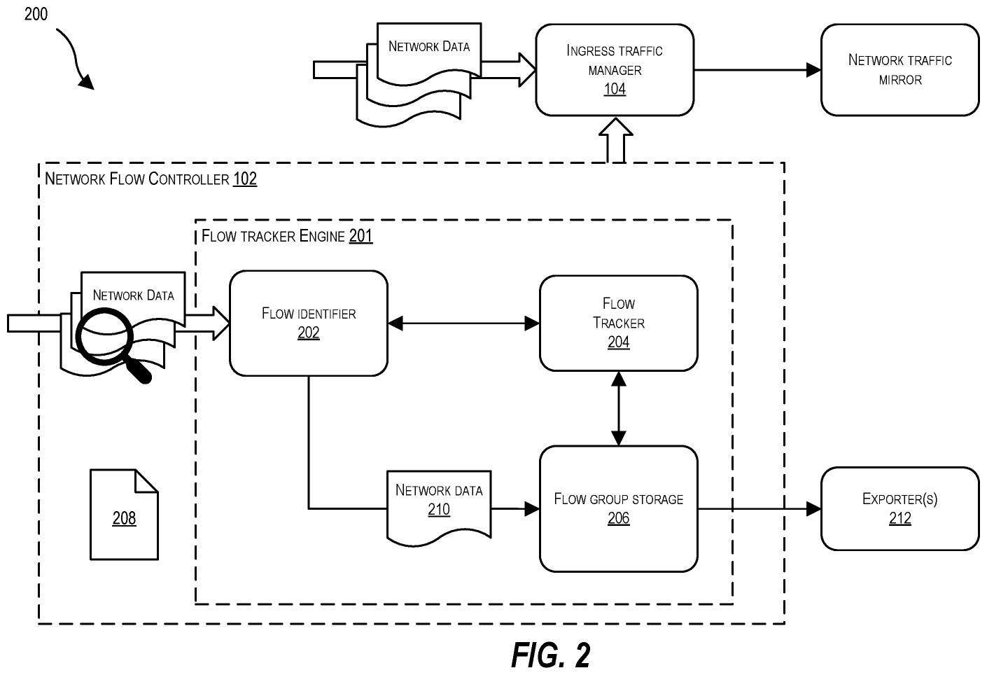

FIG. 2 illustrates an environment 200 in which the network flow controller 102 of the network management system 100 operates according to one or more embodiments. The network flow controller 102 is comprised of one or more flow tracker engines 201. Each flow tracker engine 201 includes a flow group identifier 202 that inspects network data received and identifies target network flows that have a set of characteristics corresponding to a defined set of characteristics. The network flow controller 102 also includes a flow tracker 204 that implements one or more rules associated with the target flow groups. The network flow controller 102 further includes flow group storage 206 that stores flow information regarding network data associated with the target flow groups. In some embodiments, the network flow controller 102 is configured to export and/or cause exportation of flow information of a target flow group or data packets of the target flow group. For instance, the network flow controller 102 may include or be operationally coupled to one or more exporters 212 that are configured to obtain a collection of data packets and associated metadata of target flow groups stored in the flow group storage 206 and export the collection to one or more destinations. Examples of flow information include, by way of non-limiting example, an amount of network data received for the target flow group, source or destination information, encapsulation of data packets in the target flow group.

The flow group identifier 202 filters the network data that does not correspond to a target network flow and may forward network data of a target network flow to the flow tracker 204 and/or the flow group storage 206. The flow group identifier 202 includes encoded logic that efficiently filters network data. In some embodiments, the flow group identifier 202 includes processing circuitry configured to identify target flow groups, and may include encoded instructions stored on a computer readable medium that, as a result of execution by the processing circuitry, causes the processing circuitry to perform as discussed herein. By way of non-limiting example, the processing circuitry may include an ASIC, an FPGA, or a system-on-chip. In some embodiments, the flow group identifier 202 is implemented as a collection of memory blocks that stores a plurality of forwarding rules for forwarding data packets (e.g., forwarding tables). In some embodiments, the flow group identifier 202 may be implemented in a cloud-based computing system and/or as a microprocessor executing encoded instructions stored in memory.

The flow tracker 204 may be implemented as one or more processors with encoded logic, such as field-programmable gate arrays, ASICs, systems on chip (SoC), or processing units (e.g., x86-64 microprocessors) coupled to memory storing executable instructions. The flow group identifier 202 may mark one or more data packets as belonging to a particular flow group from among a plurality of defined flow groups. For instance, as a result of determining that a network traffic flow belongs to a particular defined flow group, the flow group identifier 202 may modify a header of one or more data packets of the network traffic flow to identify the particular defined flow group to which the data packets belong.

The flow group storage 206 includes memory that is communicatively coupled to the flow tracker 204 and the flow group identifier 202, the memory storing one or more data structures described herein. As a non-limiting example, the flow group storage 206 may store data packets provided by the flow tracker 204 and may store one or more data structures, such as a session table, that record states of network data received from the flow group identifier 202. The flow group storage 206 may store some or all of the received data packets from the flow group identifier 202 based on the marking provided by the flow group identifier 202. The flow group storage 206 may also update a corresponding data structure (e.g., session table) based on the marking provided by the flow group identifier 202, such as by updating a field indicating a number of packets received for the particular network flow, the amount of data received for the particular network flow, a quality of service associated with the particular network flow, an indication of a security risk associated with the particular network flow, etc.

The network flow controller 102 also stores or maintains a set of flow group rules 208 that identify the set of target flow groups and define rules for how to handle network data of the set of target flow groups. The flow group identifier 202, the flow tracker 204, and/or the flow group storage 206 may perform various operations based on content of the flow group rules 208. The flow group rules 208 identify a set of characteristics for each of the target flow groups. A target flow group in the flow group rules 208 may be classified based on one or more target group attributes. The target group attributes may include one or more attributes based on packet attributes, derived attributes, or other attributes of a target flow group. In some embodiments, the one or more attributes may include elements of TCP/IP connections (e.g., 3-tuple, 5-tuple, N-tuple), such as communication protocol, source IP address, source port, destination IP address, and/or destination port, as a few non-limiting examples. As a specific example, the flow group rules 208 may identify a target flow group as being IPv6 packets that are coming from a particular source IP address (e.g., 3201:af8:d3b:80f4::1) or a range of IP addresses. In some embodiments, the one or more attributes may include one or more attributes for one or more communication layers, such as attributes related to the application layer, attributes related to the transport layer, attributes related to the network layer, attributes related to the data link layer, and/or attributes related to the physical layer.

The flow group identifier 202 identifies data packets of the target flow groups based on the target group attributes specified in the flow group rules 208. In some implementations, the flow group identifier 202 may identify data packets of a target flow group based on a correspondence between the data packets and a stored data structure, such as an access list. The flow group rules 208 specify actions to be performed for the target flow groups, such as sampling the target flow groups. For instance, the flow group rules 208 may specify that data packets 210 of a certain target flow group are to be stored in the flow group storage 206. The flow group rules 208 may specify sampling intervals for a target flow group, such specifying that the first M packets of a first target flow group or that every Nth packet of a second target flow group are to be stored in the flow group storage 206, where M and N are integer values. In some embodiments, the flow tracker 204 may perform a hash function involving network data received.

The flow group rules 208 may specify a set of characteristics of a target flow group to be tracked. One or more data structures (e.g., session table, hash table) in the flow group storage 206 may be implemented to track the set of characteristics of the target flow group. By way of non-limiting example, the flow group rules 208 may include a rule to track or monitor a number of data packets or bytes for a certain target flow group, a rule to track packet attributes (e.g., type of service, destination ethernet address, source ethernet address), or a rule to track derived attributes of network data (e.g., egress interface identifier, next hop IP). As a result, an entry in a data structure may be updated to reflect the number of data packets or bytes received for the target flow group. As another example, the flow group rules 208 may indicate that the destination IP addresses for a given flow group are to be tracked and so an entry in a data structure stored in the flow group storage 206 may be updated to indicate the destination IP addresses for a target flow group. The flow tracker 204 may interact with the flow group identifier 202 and/or with the flow group storage 206 to determine a status for each of the set of characteristics of the target flow group(s).

The flow group rules 208 may specify a set of criteria for evaluating a target flow group and a set of operations associated with one or more of the set of criteria. The set of criteria may include criteria related to an amount of network data received, criteria related to timing, criteria related to data similarity, or other criteria. By way of non-limiting example, the flow group rules 208 may specify that, for every number N of defined number of data packets or every number N of bytes of a target flow group (where N is an integer value), a corresponding operation is to be performed. As another example, the flow group rules 208 may specify that, as a result of receiving number N of defined number of data packets or a number N of bytes of a target flow group (where N is an integer value), a corresponding operation is to be performed. As a further example, the flow group rules 208 may specify that a set of defined operations is to be performed at a defined time interval or after a defined interval of data packets is received.

The flow group rules 208 may include operations to be performed as a result of the target flow group satisfying the defined set of criteria. In some implementations, the flow tracker 204 may monitor a status of a target flow group relative to one or more sets of criteria specified in the flow group rules 208 and cause corresponding operations to be performed as a result of determining that a set of criteria is satisfied. In some implementations, the operations involve causing data packets to be transported to one or more destinations. For instance, the flow tracker 204 may instruct the flow group storage 206 to provide stored flow information regarding a flow being tracked to an exporter 212. The exporter 212 may then export the flow information to a certain destination, which may be a defined destination for the exporter 212 or may be a destination identified in the set of rules 208.

The data obtained and exported may include metadata (e.g., 5-tuple characteristics) associated therewith. The destination to which the data is exported may be an entity responsible for monitoring security, performance, or administration of the network and/or devices therein. As another example, the network flow controller 102 may instruct the ingress traffic manager 104 to adjust the flow of network traffic. The flow tracker 204 may instruct the ingress traffic manager 104 to mirror a target flow group on a certain port of a network traffic mirror 214 or to a specific destination, may instruct the ingress traffic manager 104 to discontinue data packet transmission of a target flow group, or may instruct the ingress traffic manager 104 to redirect data packet transmission of a target flow group to a different destination.

Data may be stored in the flow group storage 206 for tracking characteristics associated with the defined network flows. For instance, data may be stored in the flow group storage 206 regarding a number of packets, an interval of data packets (e.g., where data packets received are relative to another point in the network flow), or an amount of data transported for a flow group. In some implementations, data may be stored in the flow group storage 206 regarding a quality of service of a defined flow group, such as latency, throughput, jitter, or error rate associated with a target network flow, by way of non-limiting example. In some implementations, data may be stored in the flow group storage 206 regarding a security risk associated with a defined flow group. Other characteristics associated with the defined network flows may be implemented depending on the application. Data regarding these characteristics may be used to determine whether a defined set of criteria are satisfied for the defined flow group.

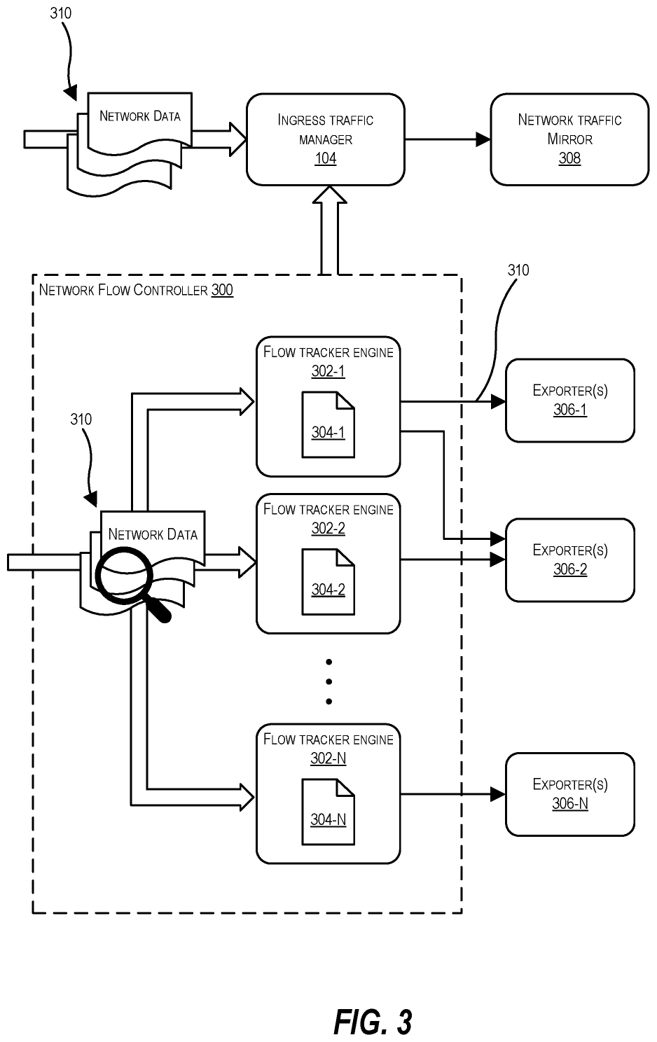

FIG. 3 illustrates an environment in which an example network flow controller 300 operates to implement a plurality of flow tracker engines according to one or more embodiments. The network flow controller 300 includes a plurality of flow tracker engines 302-1, 302-2, . . . 302-N (collectively “flow tracker engines 302”) that track and control network data 310, as described herein. Each of the flow tracker engines 302 includes a flow group identifier 202, a flow tracker 204, and flow group storage 206, as described herein with respect to FIG. 2 and elsewhere. Each of the flow tracker engines 302 is established with a corresponding set of flow group rules 304-1, 304-2, . . . 304-N (collectively “flow group rules 304”) that define flow groups and operations to be performed based on a set of defined criteria, as described above with respect to FIG. 2. For example, a first flow tracker engine 302-1 of the network flow controller 300 operates according to a first set of rules 304-1, a second flow tracker engine 302-2 operates according to a second set of rules 304-2, and so forth. This allows for different flow tracking and capabilities to be established for different groups of users, network segments, different types of computing systems, etc.

Each set of rules of the flow group rules 304 may be individually modified without affecting other sets of rules or operation of the other flow tracker engine 302. For instance, a network administrator may modify the first set of rules 304-1 to adjust operation of the first flow tracker engine 302-1 without affecting operation of the other flow tracker engines 302-2, . . . 302-N. Moreover, the sets of rules 304 may be modified during operation of the network such that a particular rule for a defined flow group can be added, modified, or deleted within a given set of rules without affecting other rules within the same set of rules. By way of non-limiting example, for the first flow tracker engine 302-1, a first flow group is defined by one or more rules of the first set of rules 304-1 and a second flow group is defined by different rules of the first set of rules 304-1. While the network flow controller 300 is operating and the flow tracker engines 302 are controlling network data for their respective flow groups, the first set of rules 304-1 may be modified to add a third flow group having a new set of rules and the rule(s) for the first flow group may be modified without discontinuing operation of the first flow tracker engine 302-1. Advantageously, this enables the flow group rules to be modified without exposing a security risk or gap.

The network flow controller 300 may be coupled to a set of exporters 306-1, 306-2, . . . 306-N (collectively the “set of exporters 306”) for exporting network data according to the sets of rules 304. Individual exporters of the set of exporters 306 may be communicatively coupled to one or more corresponding flow tracker engines to export collections of network data to network entities based on the sets of rules 304. In one non-limiting example implementation, a first exporter 306-1 is communicatively coupled with the first flow tracker engine 302-1, a second exporter 306-2 is communicatively coupled with the first and second flow tracker engines 302-1 and 302-2, and an Nth exporter 306-N is communicatively coupled with the Nth flow tracker engine 302-N. In some implementations, one or more of the flow tracker engines 302 may not be communicatively coupled with any of the set of exporters 306.

The network flow controller 300 is configured to interact with the ingress traffic manager 104 based on the sets of rules 304. For instance, the first flow tracker engines 302-1 may send instructions to the ingress traffic manager 104 to mirror data packets via one or more specified mirror ports of a network traffic mirror 308 for one or more defined flow groups based on the first set of rules 304-1.

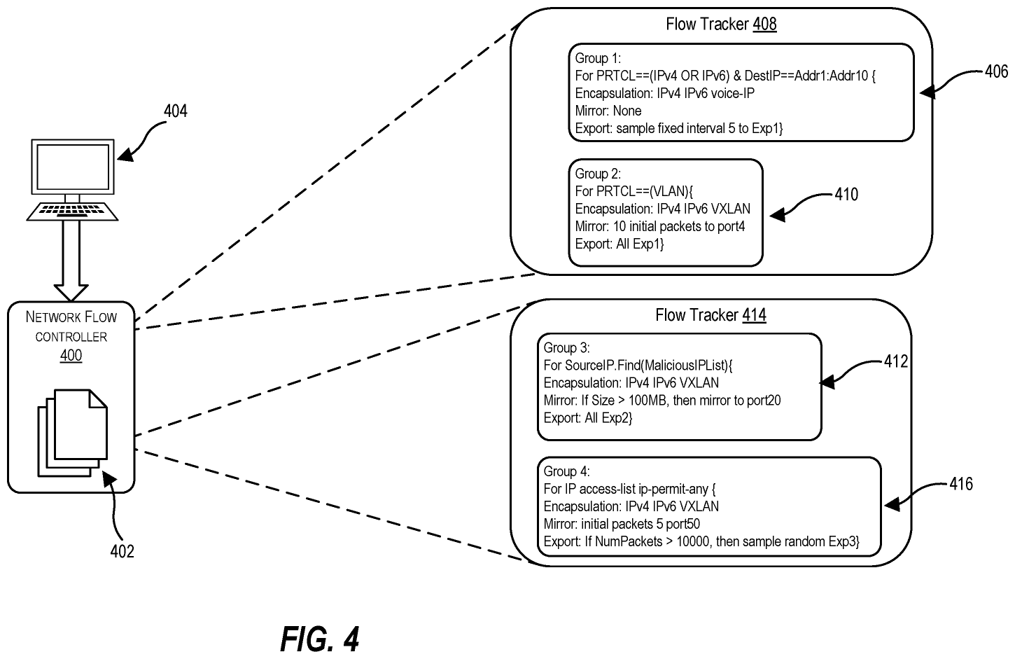

FIG. 4 shows an example environment in which a network flow controller 400 operates based on sets of rules according to one or more embodiments. The network flow controller 400 stores one or more sets of rules 402 that are each to be implemented via a corresponding flow tracker engine, as described with respect to FIG. 3 and elsewhere herein. Each of the sets of rules 402 may be received as user input from one or more computer systems 404. A user may provide an input for establishing, modifying, or removing the sets of rules 402 via a user interface, via command line, or as a batch file, by way of non-limiting example. Various example rule sets will now be described with respect to FIG. 4; however, it is understood that these examples are non-restrictive illustrations of the myriad ways in which the embodiments herein may be implemented and do not limit the scope of the present disclosure.

A first set of rules 406 is implemented by a first flow tracker 408. The first set of rules 406 defines a flow group 1 as being network flows that are formatted according to either the IPv4 protocol or the IPv6 protocol, and that have a destination IP address in an IP address range of Addr1 to Addr10. For flows of data packets that match the characteristics of flow group 1, the data packets may be tunneled via encapsulations IPv4, IPv6, or voice over IP packets. Also, the first set of rules 408 dictate that every fifth data packet is to be sampled and provided to an exporter Exp1, which may be configured to export the sampled data packet to a defined destination, such as a security or a network quality analyzer. Note that no data packets are to be mirrored according to the first set of rules 406.

A second set of rules 410 is also implemented on the first flow tracker 408. The second set of rules 410 defines a second flow group as corresponding to network packets encoded according to a Virtual Local Area Network protocol (e.g., transmitted via a Peer-to-Peer Virtual Private Network). For flows of data packets that match the characteristics of flow group 2, the data packets may be tunneled via encapsulations within IPv4, IPv6, or VXLAN packets. The data packets may be encapsulated via other protocols described elsewhere herein. The second set of rules 410 also specifies that the first initial ten data packets of a network data flow matching the characteristics of flow group 2 are to be mirrored via port 4. For instance, the flow tracker 408 may send instructions to the ingress flow manager 104 to mirror the first ten packets via port 4 or may interface with the network traffic mirror 308 to send the first ten packets (see FIG. 3). The second set of rules 410 further specifies that all data packets matching the flow group 2 are to be exported to the exporter Exp1.

A third set of rules 412 is implemented by a second flow tracker 414, which may be for tracking and controlling network flows for a different set of users, a different network segment, or a different set of computer systems than the first flow tracker 408. The third set of rules 412 specifies that a third flow group corresponds to data packets having a source IP address that is included in a list of known malicious IP addresses. In some embodiments, the second flow tracker 414 is configured to perform a hash function on an IP address and compare the resulting hash value with corresponding hash values of the list of known malicious IP addresses to determine whether the source IP address corresponds to the third flow group. The third set of rules 414 specify a set of criteria for mirroring involving a size. In particular, the third set of rules 414 specify that if the amount of data received for the third flow group exceeds a defined threshold (e.g., 100 MB), then the second flow tracker 414 is to cause packets to be mirrored from a certain port. The third set of rules 414 also indicate all data packets of the third flow group are to be provided to an exporter Exp2, which may be configured to export the data packets to a security analyzer.

A fourth set of rules 416 is implemented by the second flow tracker 414. The fourth set of rules 416 specifies that a fourth flow group corresponds to all other data packets not belonging to the third flow group. Information identifying network flows belonging to the fourth flow group is added to an access list entitled “ip-permit-any.” Such information may include some or all of the 5-tuple information, number of data packets received, amount of data received, or other information contained in data packet headers. The information regarding a particular flow group may be aggregated in the access list and used to determine whether the flow group satisfies one or more criteria. For instance, the fourth set of rules 416 specify that, if the number of packets received for a particular flow group exceeds 10,000, then random data packet samples are provided to the exporter Exp3. The fourth set of rules 416 also specifies that the first five initial packets of a flow group are to be mirrored on port 50, which may be an ethernet port coupled to a data analyzer.

Criteria other than those described with respect to FIG. 4 may be implemented for controlling transmission of data packets. In some embodiments, criteria involved in a set of rules may relate to indicators of network quality and may involve defined thresholds related to network quality or quality of service. In some embodiments, criteria involved in a set of rules may involve security risks or may include one or more criteria involving a time threshold—for instance, a set of rules may dictate controlling transmission of data packets if a defined network flow continues for a time period exceeding a defined time threshold.

A plurality of sets of criteria may be established for an individual defined flow group to establish patterns for handling network flows based on different conditions. Hierarchies of flow groups may be established such that a network flow with characteristics matching two or more flow groups are evaluated in a defined order. As an example, the fourth set of rules 416 associated with the fourth flow group may be considered a default flow group with which network flows are associated that fail to satisfy the set of criteria of the third set of rules 412.

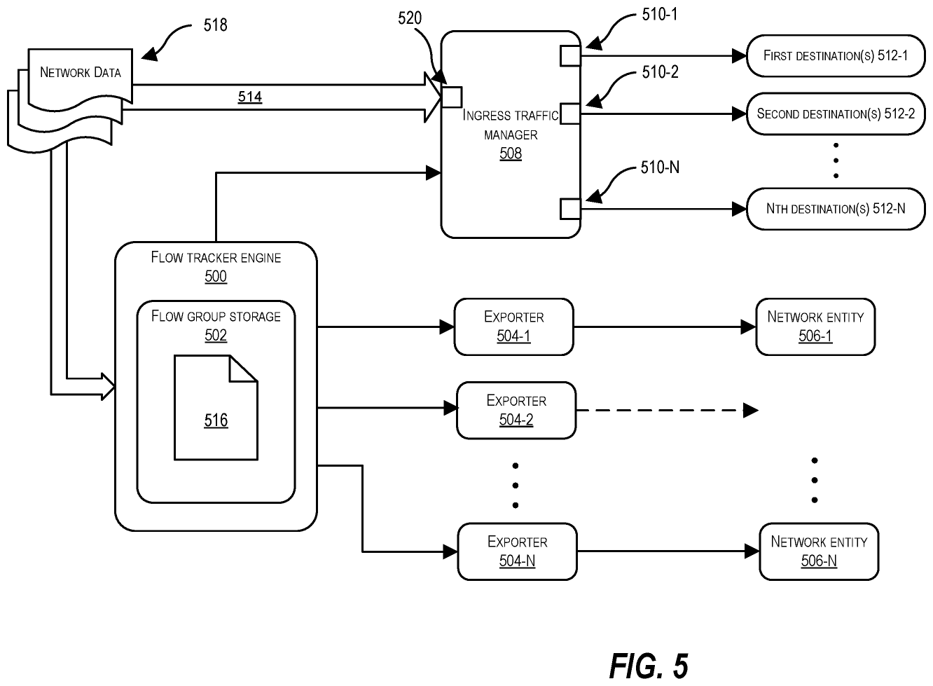

FIG. 5 illustrates an example environment in which a network flow controller 500 operates according to one or more embodiments. The network flow controller 500 includes flow group storage 502 that is configured to store data associated with defined network flows. The data stored in the flow group storage 502 may include data packets, metadata, and other information regarding characteristics of the defined flow groups, as described herein.

The flow tracker engine 500 is communicatively coupled with a set of exporters 504-1, 504-2, . . . 504-N (collectively the “set of exporters 504”) for aggregating and exporting collections of data regarding one or more of the defined flow groups. Each of the set of exporters 504 may receive data packets or information regarding data packets from the flow tracker engine 500 based on certain operations specified in a corresponding set of rules. As described above with respect to FIG. 4, the flow tracker 408 may export information regarding a sample of every fifth data packet to a certain exporter, such as the exporter 504-1 of FIG. 5, for example. Moreover, the flow tracker 408 may export, to the exporter 504-1, information associated with the first flow group associated with the first set of rules 406. The information associated may include 5-tuple information (e.g., source IP address, destination port), times indicating the start or end of the defined flow group, number of packets in the flow, or amount of data in the flow, by way of non-limiting example. In some implementations, the information provided to the exporter may include information regarding a security risk of the associated flow group, network quality information associated with one or more flow groups, or information regarding quality of service associated with the associated flow group (e.g., Differentiated Services Code Print).

One or more of the set of exporters 504 are communicatively coupled with a plurality of network entities 506-1, . . . 506-N (collectively “network entities 506”) to which the respective exporters export collections of data, e.g., periodically, based on the amount of data received and currently stored by the exporter, etc. For instance, the exporter 504-1 may include an allocated amount of data storage and the exporter 504-1 may be configured to export the contents stored to the network entity 506-1 to prevent overwriting the stored data or overrunning the defined boundaries of the data storage. The network entities 506 include computer systems that are configured for security analysis, network performance analysis, data management, or other aspects of network administration. In some implementations, one or more of the exporters 504 may be a dummy exporter that is not connected to export data to a network entity. For instance, the exporter 504-2 is unconnected to any of the network entities 506 such that data exported by the exporter 504-2 is dropped or “blackholed.” Dummy exporters may be established for network flows that are, for example, not considered a security risk or that may be duplicative.

The set of exporters 504 may be implemented by logic encoded in one or more processors. In some embodiments, one or more of the processors corresponding to the set of exporters 504 may include embedded logic such as an application specific integrated circuit (ASIC), digital signal processor (DSP), or a system on chip (SoC). In some embodiments, one or more of the processors may include a processing unit (e.g., x86-64 microprocessors) coupled to computer readable storage media that stores executable program code that causes the processing unit to perform operations described herein.

The flow tracker engine 500 may be communicatively coupled to an ingress traffic manager 508 in some implementations. The ingress traffic manager 508 includes a plurality of output or destination ports 510-1, 510-2, . . . 510-N (collectively “output ports”) that are each communicatively coupled to transport data packets to one or more network destinations. For instance, a first output port 510-1 is coupled to transport data packets to a first set of destinations 512-1, a second output port 510-2 is coupled to transport data packets to a second set of destinations 512-2, and an Nth output port 510-N is coupled to transport data packets to an Nth set of destinations 512-N. The ingress traffic manager 508 may include a network traffic mirror, as discussed elsewhere herein (e.g., the network traffic mirror 308 discussed with respect to FIG. 3). The network destinations 512-1, 512-2, . . . 512-N (collectively the network destinations 512) are entities internal to a network, such as end user computer systems, servers, or administrative entities, such as network security analysts or network performance analysts. The ingress traffic manager 508 is coupled to receive ingress network traffic 514 via one or more input or source ports 520 from one or more external sources over the network 110 (see FIG. 1). In some implementations, one or more of the network entities 506 may be logically or physically the same as one or more of the network destinations 512. As an example, the network entity 506-1 and the network destination 512-1 may both be the same server that receives mirrored packets and flow information.

In operation, the ingress traffic manager 508 receives network traffic comprising data packets at the input port(s) 520 and transmits the data packets via one of the output ports 510. The output port(s) 510 from which the data packets are transmitted and/or the destination(s) 512 to which the data packets are transmitted may be based on configuration information for the ingress traffic manager 508 specified by an authorized user. The ingress traffic manager 508 may, for example, transmit a network traffic flow via an output port specified in settings provided by a network administrator to a certain destination of the destinations 512. The flow tracker engine 500 may, based on a set of rules 516 for one or more flow groups, cause the ingress traffic manager 508 to modify one or more flows of network traffic. In particular, the flow tracker engine 500 may send, as a result of a determination that characteristics of a defined flow group satisfy a set of criteria specified in the set of rules 516, instructions to the ingress traffic manager 508 to modify a corresponding network flow.

For instance, the ingress traffic manager 508 may receive data packets 518 of ingress network traffic 514 and transmit the data packets 518 via the output port 510-1 to a first destination 512-1. The flow tracker engine 500 also receives the data packets 518 and determines that the data packets 518 correspond to a defined target flow group and satisfy a set of criteria specified in the set of rules 516. The set of rules 516 may specify that, if the flow group satisfies the set of criteria, the corresponding data packets 518 are to be mirrored on the port 510-2. In response, the flow tracker engine 500 sends instructions to the ingress traffic manager 508 to mirror the data packets 518 corresponding to the flow group on the output port 510-2. Mirroring the data packets on the output port 510-2 is in addition to and without disruption or discontinuation of transmission of the data packets from the port 510-1. The set of rules 516 may specify, in some implementations, that the data packets corresponding to the flow group is to be outputted (e.g., mirrored) from a plurality of the ports 510.

In some implementations, the set of rules 516 include instructions to change a forwarding port of data packets of a defined flow group to a different output port based on the set of criteria. As a result of the data packets 518 satisfying the set of criteria specified in the set of rules 516, the flow tracker engine 500 may send instructions to the ingress traffic manager 508 to forward data packets of the defined group from port 510-2, for example, instead of from port 510-1. In some implementations, set of rules 516 may specify that data packets of the defined flow group are to be forwarded to a plurality of ports different than the output port 510-1.

In some implementations, the set of rules 516 may specify forwarding of data packets of the defined flow group to the output port 510-1, for example, is to be discontinued based on the set of criteria. As a result of the data packets 518 satisfying the set of criteria specified in the set of rules 516, the flow tracker engine 500 may send instructions to the ingress traffic manager 508 to discontinue transmitting data packets of the defined flow group from the port 510-1.

The set of rules 516 may specify that the data packets of a defined flow group are to be metered based on the set of criteria. As a result of the data packets 518 satisfying the set of criteria specified in the set of rules 516, the flow tracker engine 500 may send instructions to the ingress traffic manager 508 to meter data packets of the flow group. For instance, the flow tracker engine 500 may send instructions to the ingress traffic manager 508 to limit or restrict the data rate at which data packets of a defined flow group are transmitted as a result of the data packets 518 satisfying the set of criteria specified in the set of rules 516. Limiting the data rate of the data packets of the defined flow group may include storing data packets of the defined flow group in memory (e.g., a cache) and outputting the stored data packets at a desired rate. In some embodiments, limiting the data rate may include controlling, by the flow tracker engine 500, the ingress traffic manager 508 to output the data packets of the defined flow group to a particular port that is connected to the memory and controlling the memory to output the data packets to a particular network destination and/or from a particular port at a defined data rate. In some embodiments, limiting the data rate may include assigning, by the flow tracker engine 500, the flow group to a data rate limited access list.

In some implementations, the set of rules 516 specify that a Quality of Service is to be adjusted for a defined flow group. As a result of the data packets 518 satisfying the set of criteria specified in the set of rules 516, for instance, the flow tracker engine 500 may send instructions to the ingress traffic manager 508 that adjust parameters related to Quality of Service for the defined flow group. For instance, the flow tracker engine 500 may adjust parameters related to priority queue for use in forwarding, network bandwidth, latency, jitter, and/or error rate for the defined flow group. The flow tracker engine 500 may also adjust parameters for controlling how data packets for the defined flow group are prioritized (e.g., increasing priority, decreasing priority). The set of rules 516 may specify, in some implementations, that data packets for a defined flow group are to be marked by changing certain field markers or bits in the header of the data packets, which may enable the data packets to be tracked for analysis of network performance.

FIGS. 1 to 5 describe systems and devices that are located at an ingress interface of a private network, such as a corporate network or a datacenter. The ingress traffic manager 104, for instance, is a part of a network device located at an edge of a local area network. The network flow controller 102 is also located at the edge of the local area network and may be part of the same device as the ingress traffic manager 104 or may be part of a different device.

In some embodiments, one or more of the network flow controllers 102 may be located elsewhere in a network and be configured to control network flows in other parts of the network. FIG. 6 illustrates an example network flow system 600 in which a network flow controller 602 operates according to one or more embodiments. The network flow system 600 is located at an egress interface of a network and includes a network flow controller 602 that is substantially similar to one of the network flow controller(s) 102 described with respect to FIG. 1 and elsewhere herein, so description thereof is limited for brevity. The network flow system 600 is located on an edge of a network where a local network interfaces with entities external to the local network. In contrast to the network management system 100, the network flow system 600 controls or modifies flows of network traffic transmitted from the local network to external entities, such as one or more external computer systems 608 that are substantially similar to those described with respect to FIG. 1.

One or more network entities 610 generate network data 612 to be transmitted over a network 614 to the external entities. The network flow system 600 includes an egress traffic manager 604 that receives and transmits the network data 612 via one or more ports. The egress traffic manager 604 is similar to the ingress traffic manager 104, but instead handles network traffic after a forwarding decision has been made to determine an output port. The network flow controller 602 also receives the network data 612 and determines whether the network data 612 corresponds to a defined flow groups of interest defined in a set of rules. The network flow controller 602 may cause flow information 616 regarding the defined flow group of interest to be transmitted to one or more network entities 618 based on the set of rules. The network flow controller 602 may also send instructions 620 to the egress traffic manager 604 to, for example, mirror, discontinue, reroute, meter, or adjust transmission of data packets on various ports, as described with respect to FIGS. 4 and 5 and elsewhere herein. The structure and operation of the network flow system 600 are substantially similar to FIGS. 1 to 5 in other respects, so description thereof is omitted for brevity.

The network flow controller 102 and the network flow controller 602 may be included in the same system or in the same device in one or more embodiments. For instance, the network flow controllers 102 and 602 may be part of a single network device, such as a network switch or a router. In some embodiments, a network flow controller may be located on an interior of the local network and be configured to monitor and control flows of network data within the local network—for example, between network entities internal to the local network.

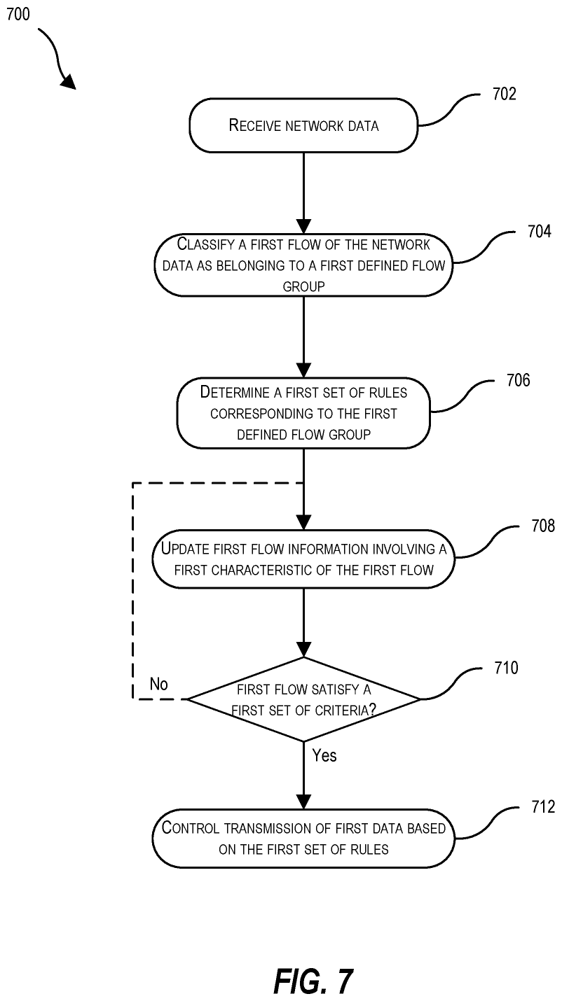

FIG. 7 shows a method 700 of controlling flows of network traffic according to one or more embodiments. The method 700 may be performed by one or more network devices described herein, such as the network flow controllers 102 or 602. The method 700 includes receiving, by a network device, network data. The network data may be received at an ingress point of a local network, an egress point of a local network, or at an intermediate point within a local network by a network device. The network data may include one or more sequences of data packets received in 702 over a period of time.

The method 700 also includes classifying, at 704, by the network device, a first flow of data packets of the network data as belonging to a first defined flow group from among a plurality of defined flow groups. The first flow may be classified in 704 based on one or more characteristics of a set of packets of the network data, such as N-tuple information contained in a header packet (e.g., source IP address, a TCP/IP protocol of a data), based on inclusion of a set of data packets of the network data in an access list, or other characteristics of a set of data packets of the network data. For instance, as described with respect to FIG. 4, a network device may classify a set of data packets as belonging to a defined flow group based on the second set of rules 410 as a result of the network data including data packets encoded based on a VLAN protocol. In some implementations, the defined flow groups may be arranged hierarchically such that the network device compares one or more characteristics of the first network data with a plurality of defined flow groups in a certain order. If the network data received in 702 does not include characteristics corresponding to a first defined flow group, the network device will then compare the network data with one or more characteristics of a second defined flow group, and so on.

At 706, the method 700 includes determining a first set of rules that correspond to the first defined flow group. The first set of rules may specify various operations to be performed involving data packets of the first flow, such as mirroring data packets from a certain port or to a certain destination, exporting information regarding data packets of the first flow, or performing other operations involving transmission of the data packets of the first flow in the local network. Determining the first set of rules 706 may include obtaining the set of rules from memory and establishing certain data structures associated with evaluating data packets of the first flow in view of the first set of rules, such as initializing counters, establishing a session table in memory (e.g., in the flow group storage 206), or adding entries in a session table for the first flow. The network device may populate one or more entries of the session table to include information regarding the first flow, such as packet attribute information, derived attribute information, etc., from a data packet header of data packets of the first flow. The network device may establish one or more entries in the session table for tracking information relevant to a set of criteria included in the set of rules.

The method 700 further includes updating, at 708, first flow information regarding a first property or characteristic involving or related to the data packets of the first flow according to the set of rules determined in 706. Non-limiting examples of the first property include an amount of data received for the first flow, a number of data packets included in network data corresponding to the first flow, an indication of Quality of Service, and encapsulation of data packets of the first flow. The first set of rules may include one or more criteria regarding a first property of the first network data and corresponding operation(s) to be performed if one or more criteria are satisfied. The network device tracks information regarding the first property and updates first flow information stored in memory of the network device, such as updating flow information regarding one or more properties related to the first flow in a session table. With reference to the third set of rules 412 of FIG. 4, for example, a flow group storage associated with the flow tracker 414 may store flow information specifying an amount of data received from an entity having an IP address included in a list of known malicious IP addresses. As a result of the amount of data received exceeding a defined threshold specified in the third set of rules 412, the flow tracker 414 performs a defined operation for the flow group, such as sending a subset of the network data for security analysis by a designated network entity. In some implementations, updating 708 the first flow information may include updating information related to a plurality of properties of the first network data.

Updating the first flow information in 708 may be performed repeatedly until the network device determines that the first flow information for the first flow satisfies the set of criteria in the set of rules. For instance, at a first time, the network device may update, in 708, a session table regarding a status of the first characteristic of the first flow, e.g., a number of data packets received in network data of the first flow over time. Then, the network device may determine, at 710, whether the first flow information satisfies a corresponding criterion in the first set of rules. If a corresponding criterion in the first set of rules is not satisfied, then the method 700 returns to 708 and the first flow information is updated again. For instance, one criterion may involve a data packet threshold, and the network device may determine, in 710 whether the number of data packets received in the first flow exceeds a data packet threshold defined in the set of rules.

As a result of determining in 710 that the first flow satisfies the first set of criteria in the first set of rules, the method 700 includes controlling 712 transmission first data associated with the first flow based on the first set of rules. For instance, the network device may send instructions to a network traffic mirror to modify mirroring of data packets of the first flow, as described with respect to FIG. 5 and elsewhere herein. As another example, the network device may provide or otherwise cause flow information relating to or regarding the first flow to be exported by a defined exporter. Controlling 712 transmission of data packets of the first flow may include transmitting a set of data packets according to a defined interval (e.g., every X number of data packets, every Y seconds), randomly transmitting a set of data packets of the first flow, or discontinuing transmission of data packets of the first flow. In some implementations, controlling 712 transmission of data packets of the first flow may not interfere with other data packet transmissions for the first flow. For example, exporting or causing exportation of information regarding the first flow may not affect how data packets of the first flow are mirrored by a network traffic mirror.

In some embodiments, the first set of criteria may include a plurality of criteria, such as a second set of criteria related to a second property of data packets the first flow. In such embodiments, the first set of rules may involve performing other operations as a result of the second set of criteria being satisfied, and the other operations may or may not involve transmission of data packets of the first flow. For example, performance of the method 700 may include controlling transmission of a second set of packets of the first flow based on the first set of rules.

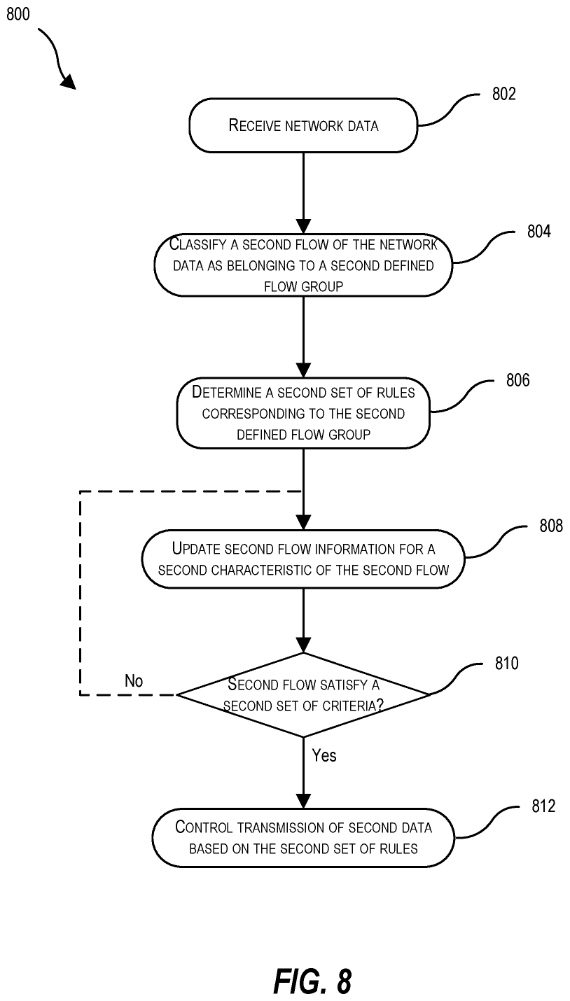

The method 700 of controlling flows of network traffic may include controlling a plurality of network flows according to one or more embodiments. For example, the network device may control a second flow of data packets of the network data according to a second set of rules. FIG. 8 shows a method 800 of controlling a second flow of network data according to one or more embodiments. The method 800 may be performed in connection with performance of the method 700, such as performing at least some operations of the method 800 in parallel with one or more operations of the method 700 or performing at least some operations of the method 800 subsequent to the operations of the method 700. Various features of the method 800 are similar to the method 700 but involve a different flow of network traffic and a different set of rules. Therefore, an in-depth description of some features of the method 800 is omitted for brevity.

The method 800 includes receiving, at 802, the network data by the network device. At 804, the method 800 includes classifying a second flow of data packets of the network data as belonging to a second defined flow group from among the plurality of defined flow groups. The method 800 includes, at 806, determining a second set of rules that correspond to the second flow of network data. In some implementations, determining, at 806, the second set of rules may include establishing a second session table to include an entry for second flow information regarding a second characteristic of the second flow. In some implementations, determining, at 806, may include updating an existing session table by modifying an existing entry of the second session table.

Then, the method 800 includes updating, at 808, second flow information regarding a second property or characteristic involving or related to data packets of the second flow according to the second set of rules. Updating 808 in the method 800 may be repeatedly performed until a second set of criteria are satisfied. At 810, the method 800 includes determining whether the second flow satisfies the second set of criteria associated with the second characteristic. Then, at 812, the method 800 includes controlling transmission of second data associated with the second flow as a result of the determination in 810 that the second set of criteria was satisfied.

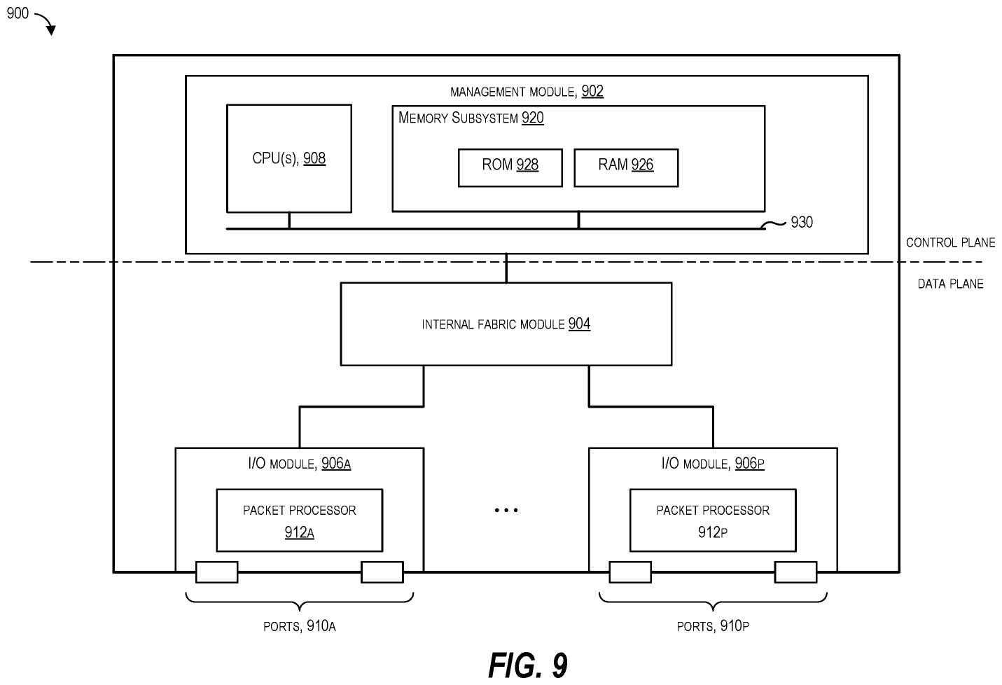

FIG. 9 depicts an example of a network device 900 that can be adapted in accordance with some embodiments of the present disclosure. The network device 900 may be a switch or a router, for example. As shown, network device 900 can include a management module 902, an internal fabric module 904, and a number of I/O modules 906a-906p. The management module 902 may be disposed in a control plane (also referred to as control layer) of the network device 900 and can include one or more management CPUs 908 for managing and controlling operation of network device 900 in accordance with the present disclosure. Each management CPU 908 can be a general purpose processor, such as an Intel®/AMD® x86-64 or ARM® processor, that operates under the control of software stored in a memory, such as a storage subsystem 920, which may include read-only memory 928 and/or random access memory 926. The control plane refers to all the functions and processes that determine which path to use, such as routing protocols, spanning tree, and the like.

Internal fabric module 904 and I/O modules 906a-906p collectively represent the data plane of network device 900 (also referred to as data layer, forwarding plane, etc.). Internal fabric module 904 is configured to interconnect the various other modules of network device 900. Each I/O module 906a-906p includes one or more input/output ports 910a-910p that are used by network device 900 to send and receive network packets. Each I/O module 906a-906p can also include a packet processor 912a-912p. Each packet processor 912a-912p can comprise a forwarding hardware component configured to make wire speed decisions on how to handle incoming (ingress) and outgoing (egress) network packets. In some embodiments, the forwarding hardware can comprise an application specific integrated circuit (ASIC), a field programmable array (FPGA), a digital processing unit, or other such collection of configured logic.

Embodiments and techniques disclosed herein include a method comprising receiving, by a network device, network data; classifying a first flow of the network data as belonging to a first defined flow group from among a plurality of defined flow groups; determining a first set of rules that apply to the first defined flow group; updating first flow information regarding a first characteristic of the first flow according to the first set of rules; determining, based on the first flow information, that the first flow satisfies a first set of criteria involving the first characteristic; and controlling, based on the first set of rules, transmission of first data associated with the first flow as a result of determining that the first flow satisfies the first set of criteria.

In some embodiments, the method comprises classifying a second flow of the network data as belonging to a second defined flow group from among the plurality of defined flow groups; determining a second set of rules that apply to the second defined flow group; updating second flow information regarding a second characteristic of the second flow according to the second set of rules; determining, based on the second flow information, that the second network data satisfies a second set of criteria involving the second characteristic; and controlling, based on the second set of rules, transmission of second data associated with the second flow as a result of determining that the second flow satisfies the second set of criteria.

In some embodiments, the method comprises controlling, based on the first set of rules, transmission of second data associated with the first flow. In some embodiments, controlling transmission of the first data includes causing an exporter to export flow information relating to the first flow to a first network destination, and controlling transmission of the second data includes providing instructions to a network traffic mirror to modify transmission of data packets corresponding to the first flow.

In some embodiments, the first set of rules specifies a sampling parameter for controlling transmission of a first set of packets of the first flow.

In some embodiments, the method comprises storing information related to a first set of packets of the first flow in memory, wherein the first set of criteria specifies a defined threshold for the first flow, wherein transmission of the first set of packets is controlled as a result of a determination that the first flow exceeds the defined threshold.

In some embodiments, the method comprises receiving, during operation of the network device, a user request including a new rule to be implemented for the first defined flow group; and updating the first set of rules based on the user request without discontinuing operation of the network device.

In some embodiments, controlling transmission of the first data includes restricting transmission of data packets associated with the first flow.

In some embodiments, the method comprises modifying one or more data packets of the first network data to include a marker corresponding to the first defined flow group, wherein the first flow information is updated based on the marker.

Embodiments disclosed herein include a network flow controller comprising a flow group identifier configured to receive network data via a network interface; and classify a first flow of the network data as belonging to a first defined flow group from among a plurality of defined flow groups. The network flow controller comprises a flow group storage configured to receive the first flow from the flow group identifier; and update first flow information regarding a first characteristic of the first flow. The network flow controller comprises a flow tracker configured to determine, based on the first flow information, that the first flow satisfies a first set of criteria involving the first characteristic; and control, based on a first set of rules for the first defined flow group, transmission of first data associated with the first flow as a result of determining that the first flow satisfies the first set of criteria.

In some embodiments, the flow group identifier is further configured to modify one or more data packets of the first flow to include a marker that identifies the first flow as belonging to the first defined flow group, and the flow group storage is configured to update the first flow information based on the marker.

In some embodiments, the flow tracker is configured to control, based on the first set of rules, transmission of second data associated with the first flow. The flow tracker may be configured to cause an exporter to export flow information relating to the first flow to a first network destination; and instruct a network traffic mirror to modify transmission of data packets corresponding to the first flow.

In some embodiments, the flow tracker is configured to receive, during operation of the network device, a user request including a new rule to be implemented for the first defined flow group, and is configured to update the first set of rules based on the user request without discontinuing operation of the network flow controller.

In some embodiments, control of transmission of the first data by the network device includes one or more actions that modify data packet mirroring of data packets associated with the first flow, export flow information regarding the first flow, or meter network traffic associated with the first flow.

Embodiments of the present disclosure include a network interface system comprising a network traffic manager configured to receive network data; and forward the network data to corresponding network destinations. The network interface system comprises a network flow controller communicatively coupled to the network traffic manager and configured to receive the network data; classify a first flow the network data as belonging to a defined flow group from among a plurality of defined flow groups; determine a set of rules that apply to the defined flow group; update flow information for a property of the first flow; determine, based on the flow information, that the first flow satisfies a set of criteria involving the characteristic; and control, based on the set of rules, transmission of first data associated with the first flow as a result of a determination that the first flow satisfies the set of criteria.

In some embodiments, the network flow controller of the network interface system is configured to send instructions to the network traffic manager to modify port mirroring of a subset of the network data corresponding to the first flow as a result of determining that the first flow satisfies the set of criteria.

In some embodiments, the network flow controller of the network interface system is configured to provide at least a portion of the flow information to an exporter as a result of a determination that the first flow satisfies the set of criteria.

In some embodiments, the network flow controller of the network interface system is configured to modify one or more data packets associated with the first flow to include a marker that identifies the subset as belonging to the defined flow group, wherein the flow information is updated based on the marker.

In some embodiments, the network flow controller of the network interface system is configured to receive, during operation of the network interface system, a user request including a new rule to be implemented for the defined flow group; and update the set of rules based on the user request without discontinuing operation of the network flow controller.

The foregoing description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

What is claimed is:

1. A method, comprising:
receiving, by a network device, network data;
classifying a first flow of the network data as belonging to a first defined flow group from among a plurality of defined flow groups;
determining a first set of rules that apply to the first defined flow group;
updating first flow information regarding a first characteristic of the first flow according to the first set of rules;
determining, based on the first flow information, that the first flow satisfies a first set of criteria involving the first characteristic; and
controlling, based on the first set of rules, transmission of first data associated with the first flow as a result of determining that the first flow satisfies the first set of criteria.

2. The method of claim 1, comprising:
classifying a second flow of the network data as belonging to a second defined flow group from among the plurality of defined flow groups;
determining a second set of rules that apply to the second defined flow group;
updating second flow information regarding a second characteristic of the second flow according to the second set of rules;
determining, based on the second flow information, that the second network data satisfies a second set of criteria involving the second characteristic; and
controlling, based on the second set of rules, transmission of second data associated with the second flow as a result of determining that the second flow satisfies the second set of criteria.

3. The method of claim 1, comprising:
controlling, based on the first set of rules, transmission of second data associated with the first flow.

4. The method of claim 3, wherein controlling transmission of the first data includes
causing an exporter to export flow information relating to the first flow to a first network destination, and
controlling transmission of the second data includes providing instructions to a network traffic mirror to modify transmission of data packets corresponding to the first flow.

5. The method of claim 1, wherein the first set of rules specifies a sampling parameter for controlling transmission of a first set of packets of the first flow.

6. The method of claim 1, comprising:
storing information related to a first set of packets of the first flow in memory, wherein the first set of criteria specifies a defined threshold for the first flow, wherein transmission of the first set of packets is controlled as a result of a determination that the first flow exceeds the defined threshold.

7. The method of claim 1, comprising:
receiving, during operation of the network device, a user request including a new rule to be implemented for the first defined flow group; and
updating the first set of rules based on the user request without discontinuing operation of the network device.

8. The method of claim 1 wherein controlling transmission of the first data includes restricting transmission of data packets associated with the first flow.

9. The method of claim 1, comprising:
modifying one or more data packets of the first network data to include a marker corresponding to the first defined flow group, wherein the first flow information is updated based on the marker.

10. A network flow controller comprising:
a flow group identifier configured to:
receive network data via a network interface; and
classify a first flow of the network data as belonging to a first defined flow group from among a plurality of defined flow groups;
flow group storage configured to:
receive the first flow from the flow group identifier; and
update first flow information regarding a first characteristic of the first flow; and
a flow tracker configured to:
determine, based on the first flow information, that the first flow satisfies a first set of criteria involving the first characteristic; and
control, based on a first set of rules for the first defined flow group, transmission of first data associated with the first flow as a result of determining that the first flow satisfies the first set of criteria.

11. The network flow controller of claim 10, wherein the flow group identifier is further configured to modify one or more data packets of the first flow to include a marker that identifies the first flow as belonging to the first defined flow group, and the flow group storage is configured to update the first flow information based on the marker.

12. The network flow controller of claim 10, wherein the flow tracker is further configured to control, based on the first set of rules, transmission of second data associated with the first flow.

13. The network flow controller of claim 12, wherein the flow tracker is further configured to:
cause an exporter to export flow information relating to the first flow to a first network destination; and
instruct a network traffic mirror to modify transmission of data packets corresponding to the first flow.

14. The network flow controller of claim 10, wherein the flow tracker is further configured to receive, during operation of the network device, a user request including a new rule to be implemented for the first defined flow group, and update the first set of rules based on the user request without discontinuing operation of the network flow controller.

15. The network flow controller of claim 10, wherein control of transmission of the first data includes one or more actions that modify data packet mirroring of data packets associated with the first flow, export flow information regarding the first flow, or meter network traffic associated with the first flow.

16. A network interface system, comprising:
a network traffic manager configured to:
receive network data; and
forward the network data to corresponding network destinations; and
a network flow controller communicatively coupled to the network traffic manager and configured to:
receive the network data;
classify a first flow the network data as belonging to a defined flow group from among a plurality of defined flow groups;
determine a set of rules that apply to the defined flow group;
update flow information for a property of the first flow;
determine, based on the flow information, that the first flow satisfies a set of criteria involving the characteristic; and
control, based on the set of rules, transmission of first data associated with the first flow as a result of a determination that the first flow satisfies the set of criteria.

17. The network interface system of claim 16, wherein the network flow controller is configured to:
send instructions to the network traffic manager to modify port mirroring of a subset of the network data corresponding to the first flow as a result of determining that the first flow satisfies the set of criteria.

18. The network interface system of claim 17, wherein the network flow controller is configured to:
provide at least a portion of the flow information to an exporter as a result of a determination that the first flow satisfies the set of criteria.

19. The network interface system of claim 16, wherein the network flow controller is configured to:
modify one or more data packets associated with the first flow to include a marker that identifies the subset as belonging to the defined flow group, wherein the flow information is updated based on the marker.

20. The network interface system of claim 16, wherein the network flow controller is configured to:
receive, during operation of the network interface system, a user request including a new rule to be implemented for the defined flow group; and
update the set of rules based on the user request without discontinuing operation of the network flow controller.
